(19) United States
(12) Patent Application Publication
(10) Pub. No.: US 2004/0141306 A1
(43) Pub. Date: Jul. 22, 2004

(54) Method for producing light guide plate and mold for the same

(76) Inventors: Ga-Lane Chen, Fremont, CA (US); Charles Chen Leu, Fremont, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/749,045

(22) Filed: Dec. 29, 2003

(30) Foreign Application Priority Data
Dec. 25, 2002 (TW) 91137243

(51) Int. Cl. F21V 7/04

(52) U.S. Cl. 362/31

(57) ABSTRACT

A molding machine (2) for producing a light guide plate includes an injection machine (20) and a mold (22). The mold includes a first plate (222) and a second plate (221). The first plate has a slanted side wall (2262), and the second plate has a side wall (2261) opposite to the side wall of the first plate. A cavity (226) for molding a light guide plate (3) is defined between the first plate and the second plate. A fluid passageway (229) for cooling and solidifying a transparent resin injected into the cavity is provided in the first plate. The fluid passageway of the first plate is parallel to the side wall of the second plate. This enables molten resin to dissipate heat uniformly. The molten resin undergoes little or no strain as it cools and solidifies, and the resulting molded light guide plate has little or no internal strain.

### BACKGROUND OF THE INVENTION

1. Field of the Invention

The present invention relates to a method for producing a light guide plate and a mold for producing the same, especially to mold for producing a light guide plate which has no strain.

2. Description of Prior Art

Recently, liquid crystal display (LCD) devices have been rapidly improving. The market for LCD devices has been steadily growing, because their thinness saves space and because they have low power consumption.

LCDs commonly use a surface light source to provide their illumination. The surface light source includes a light guide plate, which is usually has a uniform thickness or is wedge-shaped. The light guide plate distributes light from a substantially linear source such as a cold cathode fluorescent lamp (CCFL), in order to provide substantially planar illumination to the LCD.

FIG. 6 shows a conventional molding machine used to make a light guide plate. The molding machine 1 comprises an injection machine 10 and a mold 12. The injection machine 10 includes an injection cylinder 101, a screw 102 which rotates and progresses in the injection cylinder 101, a motor 103 to drive the screw 102, a hopper 104 to feed a resin into the injection cylinder 101 and a plurality of heaters 105 mounted on the outer surface of the injection cylinder 101. The mold 12 is formed of a stationary plate 121 and a movable plate 122. In the stationary plate 121, a sprue 123 is formed toward the movable plate 122 and serves as passageway for molten resin. A runner 124 is formed along the two plate 121, 122. The runner 124 communicates with the sprue 123 with the two ends leading to a gate 125. The stationary plate 121 and the movable plate 122 are mated to form a cavity 126 for molding light guide plates. The cavity 126 communicates with the injection cylinder 101 through the gate 125, the runner 124 and the sprue 123. Inside the movable plate 122, ejecting means 127 is provided that ejects molded products when it is taken out. The cavity 126 having a wedge shape in section, and is bounded by a plane 1261 and an opposite slanted wedge surface 1262. Two fluid passageways 128 and 129 are formed in the stationary plate 121 and the movable plate 122, respectively, and are parallel to the plane 1261 and the wedge surface 1262, respectively. When the molten resin is injected into the cavity 126, they are cooled and solidified by the passageways 128, 129. The molten resin in the cavity 126 does not have a same thickness, but at the same time the passageway 129 is parallel to the wedge surface 1262. This results in a different cooling rate, then an uneven thermal stress comes into being in the molten resin. This makes the molded light guide plate strain and the optical performance of the molded light guide plate is affected.

What is needed is a mold machine that overcomes the above-mentioned problems.

### SUMMARY OF THE INVENTION

An object of the present invention is to provide a method for producing a light guide plate having no strain.

Another object of the present invention is to provide a mold for producing a light guide plate having no strain.

To achieve the above objects, the mold of the present invention includes a first plate and a second plate. The first plate has a slanted side wall, and the second plate has a side wall opposite to the side wall of the first plate. A cavity for molding a light guide plate is defined between the first plate and the second plate. A fluid passageway is provided in the first plate, for cooling and solidifying a transparent resin injected into the cavity. The passageway of the first plate is parallel to the side wall of the second plate. A concave pattern is provided on the side wall of the first plate. Alternatively, the pattern may be provided on the second plate, or may be provided on a cavity plate attached on the side wall of the first plate or the second plate. The fluid passageway is used to cool and solidify the molten resin after it has been injected and filled into the cavity. After the cooling and solidifying, the mold is opened to take out the molded light guide plate. Because the fluid passageway is parallel to the side wall of the second plate, the fluid passageway enables the molten resin to dissipate heat uniformly. The molten resin undergoes little or no strain as it cools and solidifies, and the resulting molded light guide plate has little or no internal strain. Furthermore, a pattern of concavities is formed on the side wall of the first plate or the side wall of the second plate, so as to form a corresponding pattern of diffusion dots on the surface of the molded light guide plate. These features give the light guide plate high dimensional precision.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, cross-sectional view of a first embodiment of a molding machine according to the present invention;

FIG. 2 is a flow chart of steps of a preferred method for producing a light guide plate according to the present invention;

FIG. 3 is a side elevation of a light guide plate made by the molding machine of FIG. 1;

FIG. 4 is a schematic, cross-sectional view of a second embodiment of a molding machine according to the present invention;

FIG. 5 is a side elevation of a light guide plate made by the molding machine of FIG. 4; and

FIG. 6 is a schematic, cross-sectional view of a conventional molding machine.

### DETAILED DESCRIPTION OF THE INVENTION

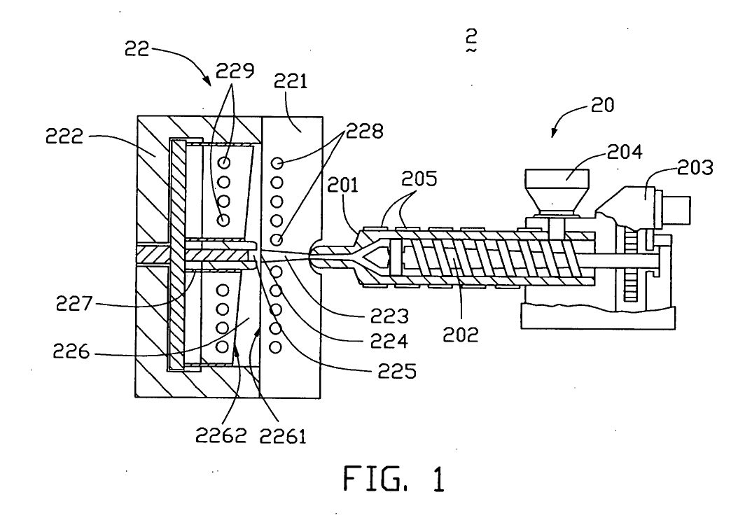

FIG. 1 shows a first embodiment of a molding machine of the present invention. The molding machine 2 includes an injection machine 20 and a mold 22.

The injection machine 20 includes an injection cylinder 201, a screw 202, a motor 203, a hopper 204, and a plurality of heaters 205. The hopper 204 feeds resin into the injection cylinder 201. The motor 203 drives the screw 202 to rotate and push the resin through the injection cylinder 201. The heaters 205 are mounted on an outer surface of the injection cylinder 201.

The mold 22 includes a stationary male plate 221 and a movable female plate 222. The female plate 222 mates with a side wall 2261 of the male plate 221, to form a wedge-shaped cavity 226. That is, mating surfaces of the female plate 222 and the side wall 2261 abut against each other. The female plate 222 has a slanted inner side wall 2262 opposite to the side wall 2261 of the male plate 221. The male plate 221 has a flared sprue 223 that serves as a passageway for molten resin. A generally zigzagged fluid passageway 228 parallel to the side wall 2261 is provided in the male plate 221, for cooling molten resin in the cavity 226. Another generally zigzagged fluid passageway 229 is provided in the female plate 222, for cooling the molten resin in the cavity 226. The fluid passageway 229 is also parallel to the side wall 2261. A runner 225 in the cavity 226 communicates with the sprue 223 at a gate 224. The cavity 226 communicates with the injection cylinder 201 of the injection machine 20 through the runner 225, the gate 224 and the sprue 223. Inside the female plate 222, an ejecting means 227 is provided for ejecting molded products after they have been cooled in the cavity 226.

Alternatively, the male plate 221 may be configured to be movable, and the female plate 222 may be configured to be stationary.

In the present invention, a pattern comprising a multiplicity of concavities (not shown) is directly engraved on the side wall 2262 of the female plate 222. The pattern is impressed on resin filled in the cavity 226, so that a pattern of diffusion dots is formed on a bottom surface of the resulting light guide plate. Sizes of the concavities of the pattern progressively increase from a thick end (not labeled) to a thin end (not labeled) of the cavity 226. The pattern is engraved on the side wall 2262 of the female plate 222 by methods such as stamping, sand blasting, etching, laser and fraise fabrication techniques, or electro-casting. Alternatively, the pattern of concavities can be directly engraved on the side wall 2261 of the male plate 221. Alternatively, the pattern of concavities can be engraved on a cavity plate. The cavity plate is then inserted into the mold 22 and attached on the side wall 2262 of the female plate 222. Alternatively, the cavity plate can be attached on the side wall 2261 of the male plate 221. Using a cavity plate is flexible, because a first cavity plate can be replaced by another new cavity plate having a different pattern of concavities when required.

The mold 22 is made from a metal having high thermal conductivity, such as copper or an alloy of copper. In particular, it is desirable to use a beryllium-copper alloy; that is, a copper alloy containing 0.3 to 3% by weight of beryllium. In order to improve the rigidity of the mold 22, a material such as Ni, NiCo, NiP, SiC, Co or TiC can be doped into the beryllium-copper alloy.

When molten resin is injected into the cavity 226, it forms a wedge-shaped mass. That is, a thickness of the molten resin gradually increases from one end of the cavity 226 to the other end. The rate of heat dissipation of the thin end of the molten resin is higher than that of the thick end. Because the fluid passageway 229 is parallel to the side wall 2261, the distance between the fluid passageway 229 and the side wall 2262 at the thick end is less than the distance between the fluid passageway 229 and the side wall 2262 at the thin end. Accordingly, the fluid passageway 229 compensates for the varying rates of heat dissipation of the molten resin between the thick end and the thin end. That is, the fluid passageway 229 enables the molten resin to dissipate heat uniformly. The molten resin undergoes minimal or no strain as it cools and solidifies. The resulting molded light guide plate has little or no internal strain.

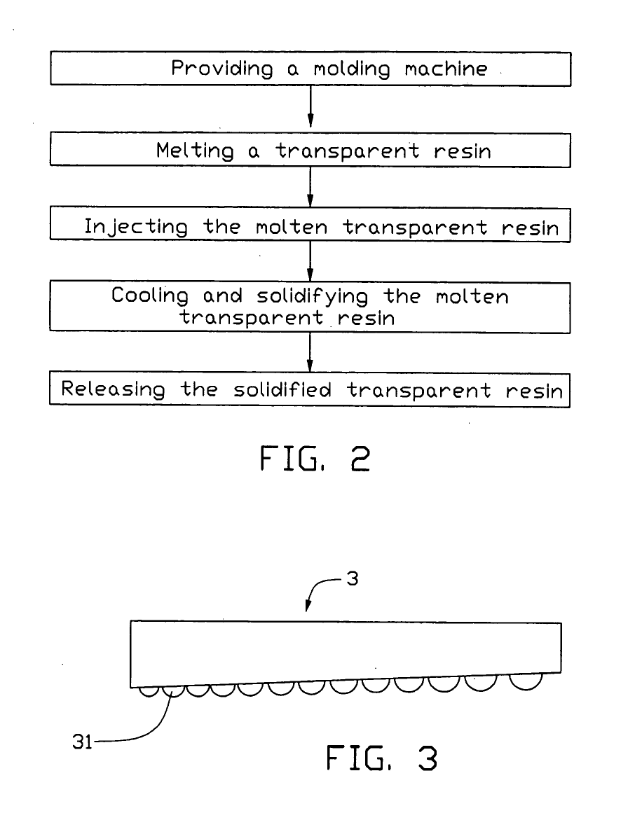

FIG. 2 is a flow chart of a preferred method for producing a light guide plate, using the molding machine 2. The method comprises the steps of:

(1) providing a molding machine;

(2) melting a transparent resin;

(3) injecting the molten transparent resin into a mold of the molding machine;

(4) cooling the molten transparent resin so that it solidifies; and

(5) releasing the solidified transparent resin from the molding machine.

In step (2), the screw 202 is rotated by the motor 203, and the resin is fed into the injection cylinder 201 via the hopper 204. The fed resin is plasticized and kneaded under heat from the heaters 205, and is conveyed to a tip of the screw 202 by the rotation of the screw 202.

Any transparent resin that satisfies the properties required of a light guide plate can be used. Examples of such resins include thermoplastic resins that can be melted and molded, such as methacrylate resin, polycarbonate, polystyrene, MS resin (which is a copolymer of methyl methacrylate and styrene), amorphous cyclo-olefin polymer, polypropylene, polyethylene, high-density polyethylene, ABS resin (which is a copolymer of acrylonitrile-butadiene-styrene), polysulfone resin, and thermoplastic polyester resin. The methacrylate resin is a polymer based on methyl methacrylate. In addition to a polymer of methacrylate alone, copolymers of methyl acrylate and a small quantity of up to 10% by weight of monomers may be used. For example, copolymers of methyl methacrylate and alkylacrylates such as methyl acrylate and ethyl acrylate may be used. Further, the resins may be mixed with a releasing agent, ultraviolet light absorber, pigment, polymerization inhibitor, chain transfer agent, antioxidant, flame retardant, etc. as necessary.

In step (3), the molten resin is continuously injected into the cavity 226 through the sprue 223 and the gate 224. The viscosity of the molten resin at the runner 225 of the mold 22 is set in the range from about 50 to about 5,000 Pa.sec, and preferably in the range from 200 to 1,000 Pa.sec. The injection rate of the molten resin is set in the range from about 1,000 to about 2,500 cm³/sec. The temperature of the molten resin in the injection cylinder 201 depends on the particular resin used. For methyl methacrylate resin, the temperature is set in the range from about 170 to about 300° C., preferably in the range from 190 to 270° C., and more preferably in the range from 230 to 260° C.

In step (4), when the cavity 226 is filled with the molten resin, the screw 202 is slightly moved back by the pressure of the filled resin. Once the screw 202 has moves back a predetermined distance, a suitable holding pressure is applied to compensate for volume shrinkage of the molten resin as it is cooled by the fluid passageways 228, 229. The fluid passageways 228, 229 are filled with a refrigerant such as water. The cooling temperature is set below 110° C., preferably at 105° C.

In step (5), the female plate 222 is opened. The molded product is ejected by the ejecting means 227, and is then taken out from the mold 22.

FIG. 3 shows a light guide plate 3 made according to the above-described method using the molding machine 2. The light guide plate 3 is wedge-shaped, and comprises a pattern of diffusion dots 31 on a bottom surface (not labeled) thereof. The diffusion dots 31 are substantially hemispherical, and correspond to a pattern of substantially hemispherical concavities engraved on the sidewall 2262 of the female plate 222.

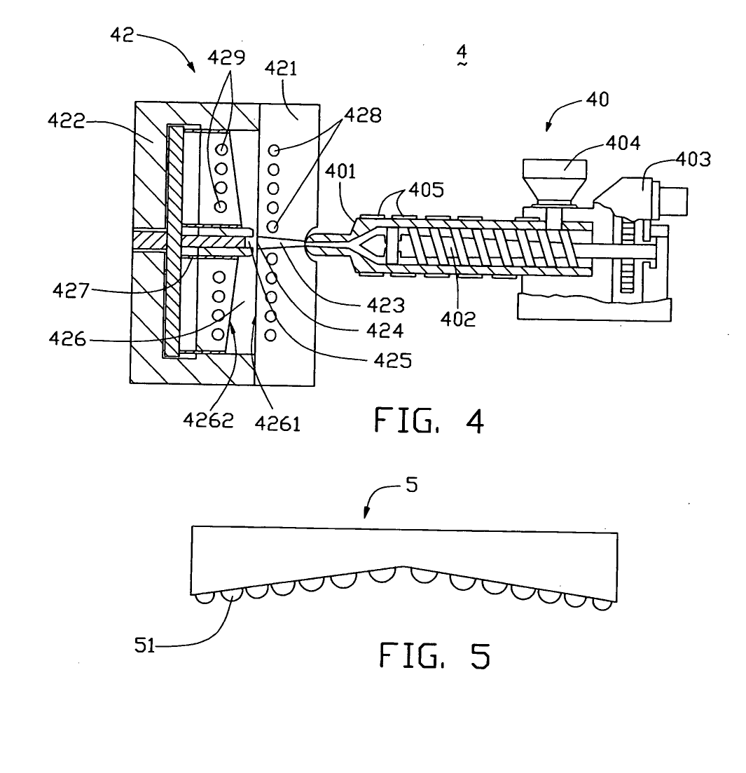

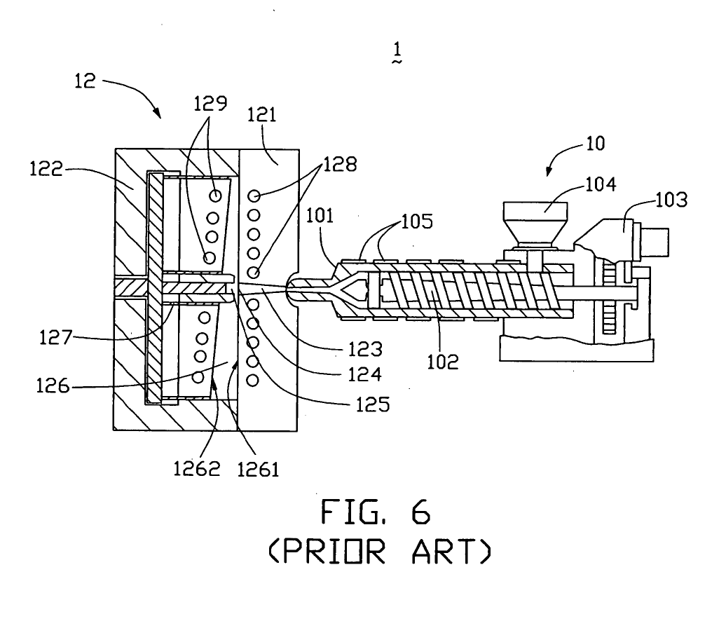

FIG. 4 shows a second embodiment of a molding machine of the present invention. The molding machine 4 is similar to the above-described molding machine 2 of the first embodiment. Like reference numerals in FIG. 4 correspond to like components in FIG. 1. A cavity 426 of a mold 42 has a symmetric shape, such that a thickness of the cavity 426 progressively increases from a center thereof to each of opposite ends thereof. Fluid passageways 428, 429 are parallel to a side wall 4261 of a male plate 421 of the mold 42.

FIG. 5 shows a light guide plate 5 made according to the above-described method using the molding machine 4. The light guide plate 5 comprises a pattern of substantially hemispherical diffusion dots 51 on a bottom surface (not labeled) thereof. The light guide plate 5 has a symmetric shape, for example a papilionaceous shape, such that a thickness of the light guide plate 5 progressively increases from a center thereof to each of opposite ends (not labeled) thereof. The diffusion dots 51 correspond to a pattern of substantially hemispherical concavities engraved on a sidewall 4262 of a female plate 422 of the mold 42.

The molding machines 2, 4 according to the present invention have the following advantages. Firstly, the fluid passageways 228, 229, 428, 429 are parallel to the side walls 2261, 4261, so that the fluid passageways 228, 229, 428, 429 cooperatively enable the molten resin to dissipate heat uniformly. The molten resin undergoes little or no strain as it cools and solidifies, and the resulting molded light guide plate 3, 5 has little or no internal strain. Secondly, the patterns of concavities corresponding to the diffusion dots 31, 51 of the light guide plates 3, 5 are directly engraved on the side walls 2262, 4262. That is, the light guide plates 3, 5 are made with high dimensional precision.

In addition, other variations of the molding machine of the present invention may be configured. In particular, the female plate 222, 422 may be configured to have patterns of other different kinds of concavities besides substantially hemispherical concavities. For example, the female plate 222, 422 may be configured to have concavities that are sub-hemispherical, cuboid, parallelepiped-shaped, frustum-shaped, etc. In a further example, the concavities may be configured to have different sizes, such that they progressively increase in size from one end of the female plate 222, 422 to an opposite end thereof. These configurations produce light guide plate having diffusion dots with the corresponding desired configurations.

It is to be further understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for producing a light guide plate, comprising the steps of:
providing a molding machine comprising an injection machine and a mold, the mold comprising a first plate and a second plate having a side wall opposite to the first plate, wherein a cavity is formed between the first plate and the second plate, the cavity communicating with a cylinder of the injection machine;
feeding a transparent resin into the cylinder;
melting the resin in the cylinder; and
injecting the molten resin from the cylinder into the cavity of the mold; and
cooling the molten resin so that it solidifies by means of a refrigerant filled in a fluid passageway that is provided in the first plate parallel to the side wall of the second plate;
wherein a viscosity of the molten resin at an inlet of the mold is in the range from about 200 to about 1,000 Pa.sec, and an injection rate of the molten resin is in the range from about 1,000 to about 2,500 cm³/sec.

2. The method for producing a light guide plate as claimed in claim 1, wherein the resin is methyl methacrylate resin.

3. The method for producing a light guide plate as claimed in claim 1, wherein the temperature of the resin in the cylinder is set in the range from about 170 to about 300° C.

4. The method for producing a light guide plate as claimed in claim 1, wherein the temperature of the resin in the cylinder is set in the range from 190 to 270° C.

5. The method for producing a light guide plate as claimed in claim 1, wherein the temperature of the resin in the cylinder is set in the range from 230 to 260° C.

6. The method for producing a light guide plate as claimed in claim 1, wherein a viscosity of the molten resin at the inlet of the mold is in the range from about 50 to about 5,000 Pa.sec.

7. The method for producing a light guide plate as claimed in claim 1, wherein the molten resin is continuously injected into the cavity with rotation of a screw in the cylinder.

8. The method for producing a light guide plate as claimed in claim 1, wherein an engraved pattern is provided on a side wall of the first plate or the side wall of the second plate, in order to provide the obtained light guide plate with a corresponding pattern of dots.

9. The method for producing a light guide plate as claimed in claim 1, wherein an engraved pattern is provided on a cavity plate that is attached on a side wall of the first plate or the side wall of the second plate, in order to provide the obtained light guide plate with a corresponding pattern of dots.

10. A mold for producing a light guide plate, comprising:
a first plate having a side wall;
a second plate having a side wall opposite to the side wall of the first plate;
a cavity for molding a light guide plate defined between the first plate and the second plate; and
a fluid passageway provided in the first plate for cooling and solidifying molten resin injected into the cavity;
wherein the fluid passageway is parallel to the side wall of the second plate.

11. The mold for producing a light guide plate as claimed in claim 10, wherein a fluid passageway is provided in the second plate, parallel to the fluid passageway of the first plate.

12. The mold for producing a light guide plate as claimed in claim 10, wherein the cavity is wedge-shaped.

13. The mold for producing a light guide plate as claimed in claim 10, wherein the cavity has a papilionaceous shape in cross-section.

14. The mold for producing a light guide plate as claimed in claim 10, wherein the mold is made of copper or a copper alloy.

15. The mold for producing a light guide plate as claimed in claim 14, wherein a material of the mold is mixed with any one or more of Ni, NiCo, NiP, SiC, Cr and TiC.

16. The mold for producing a light guide plate as claimed in claim 10, wherein an engraved pattern is provided on a side wall of the first plate or the second plate.

17. The mold for producing a light guide plate as claimed in claim 10, further comprising a cavity plate attached on the side wall of the first plate or the second plate, the cavity plate having an engraved pattern provided thereon.

18. The mold for producing a light guide plate as claimed in claim 16, wherein the pattern comprises a plurality of concavities.

19. The mold for producing a light guide plate as claimed in claim 17, wherein the pattern comprises a plurality of concavities.

20. A method of making a light guide plate comprising:
providing a mold including opposite first and second plates wherein the first plate defining a non-oblique side wall and said second plate defining an oblique side wall spatially facing to each other and commonly defining a cavity therebetween for forming said light guide plate; and
providing said second plate with a plurality of cooling fluid passageways adjacent to said oblique side wall under a condition that
said plurality of passageways are arranged in a plane with regard to the oblique side wall in a non-parallel manner.
